(19) United States
(12) Patent Application Publication
(10) Pub. No.: US 2010/0110156 A1
(43) Pub. Date: May 6, 2010

(54) DRYING APPARATUS, RECORDING APPARATUS AND METHOD FOR DRYING TARGET

(75) Inventors: Keiji HARA, Minowa-machi (JP); Osamu SHINKAWA, Chino-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/611,195

(22) Filed: Nov. 3, 2009

(30) Foreign Application Priority Data
Nov. 4, 2008 (JP) 2008-283509

(51) Int. Cl. B41J 2/01; F26B 13/00

(52) U.S. Cl. 347/102; 34/611

(57) ABSTRACT

A drying apparatus includes a transport unit that transports a target in a form of a cut sheet, on which a recording process has been performed through the attachment of liquid, from an upstream side to a downstream side of a transport direction. A drying unit performs a drying process on the transported target by blowing air toward a liquid attachment surface of the target. The drying unit is provided with a blowing port which allows air to blow toward an end portion of the target at the downstream side of the transport direction in a first direction from the upstream side to the downstream side of the transport direction, and allows air to blow toward an end portion of the target at the upstream side of the transport direction in a second direction from the downstream side to the upstream side of the transport direction.

### BACKGROUND

1. Technical Field

The present invention relates to a drying apparatus for fixing recording to a target by promoting the drying of liquid attached to the target on which the recording has been performed, a recording apparatus provided with the same, and a method for drying the target.

2. Related Art

According to the related art, an ink jet printer (hereinafter, referred to as a printer) is generally known as a recording apparatus that performs a recording operation by attaching liquid to a target. According to the printer, ink (liquid) supplied to a recording head is ejected from nozzles formed in the recording head so that printing (recording) is performed on a sheet serving as a target.

In relation to the printer, recently, as disclosed in patent document 1 (see JP-A-2003-54796), such a printer includes a drying apparatus to promote drying of ink attached to a sheet. In detail, the drying apparatus dries the ink by blowing hot wind toward the sheet with the ink attached thereto.

However, the printer disclosed in patent document 1 performs printing and drying processes on a rectangular sheet having an upstream end and a downstream end, which are wound around a shaft, in a transport direction. In this regard, when the printing and drying processes are performed on a cut sheet having a rectangular shape, an end of the cut sheet may become rolled up due to the hot wind blowing toward the cut sheet. Thus, the speed of the wind blowing toward the target may not be increased, and the drying speed of ink, which is proportional to the speed of the wind, may also not be increased.

### SUMMARY

An advantage of some aspects of the invention is that it provides a drying apparatus capable of drying liquid attached to a target at a higher speed while maintaining the flatness of the target, a recording apparatus, and a method for drying the target.

According to a first aspect of the invention, there is provided a drying apparatus including a transport unit that transports a target in a form of a cut sheet, on which a recording process has been performed through attachment of liquid, from an upstream side to a downstream side of a transport direction, and a drying unit that performs a drying process on the target transported by the transport unit by blowing wind toward a liquid attachment surface of the target, a rear surface of the target being supported by a support surface of a support member, the drying unit being provided with a blowing port which allows wind to blow toward an end portion of the target at the downstream side of the transport direction in a first direction from the upstream side to the downstream side of the transport direction, and allows wind to blow toward an end portion of the target at the upstream side of the transport direction in a second direction from the downstream side to the upstream side of the transport direction.

According to the above configuration, if the target in the form of the cut sheet, on which the recording process has been performed through attachment of liquid, is transported by the transport unit, the end of the target (that is, the front end in the transport direction) at the downstream side of the transport direction is exposed to the wind blowing in the first direction from the upstream side to the downstream side of the transport direction. In detail, when the target being transported approaches the drying unit, the front end of the target in the transport direction is exposed to the wind in the direction opposite to the direction in which the end of the target is rolled up, so that the target is pressed to the support surface. Then, when the target is transported to the downstream side beyond the drying unit, the end of the target (that is, the rear end in the transport direction) at the upstream side of the transport direction is exposed to the wind blowing in the second direction from the downstream side to the upstream side of the transport direction, which is opposite to the direction in which the end of the target is rolled up, so that the target is pressed to the support surface. That is, the drying unit can perform the drying process by blowing the wind such that the ends of the target at the downstream side and the upstream side of the transport direction are pressed to the support surface. Thus, the liquid can be dried at a higher speed by increasing the speed of the wind blowing toward the target while the flatness of the target is maintained.

According to the drying apparatus of the invention, the drying unit includes a wind direction change section that changes the direction of the wind, which blows from the blowing port to the target, by changing an angle of the blowing port with respect to the target.

According to the above configuration, the wind direction change section of the drying unit can change the direction of the wind blowing toward the target by changing the angle of the blowing port with respect to the target. That is, when the end of the target being transported at the downstream side of the transport direction approaches a position corresponding to the blowing port of the drying unit, the blowing port is directed to the downstream side, so that the target can be exposed to the wind blowing in the first direction. Then, when the target is transported and the end of the target at the upstream side of the transport direction passes through the position corresponding to the blowing port of the drying unit, the blowing port is directed to the upstream side, so that the target can be exposed to the wind blowing in the second direction. Consequently, the ends of the target at the downstream side and the upstream side of the transport direction can be prevented from becoming rolled up through this simple configuration, so that the drying process can be performed.

According to the drying apparatus of the invention, the drying unit includes a first blowing port through which wind blows in the first direction, a second blowing port through which wind blows in the second direction, and a blowing stop section that stops blowing from the first blowing port when the end portion of the target at the upstream side of the transport direction passes through a position corresponding to the first blowing port, and stops blowing from the second blowing port when the end portion of the target at the downstream side of the transport direction passes through a position corresponding to the second blowing port, the periphery of an opening of the first blowing port at the upstream side of the transport direction being located at the upstream side of the transport direction as compared with the periphery of an opening of the second blowing port at the upstream side of the transport direction, and the periphery of an opening of the second blowing port at the downstream side of the transport direction being located at the downstream side of the transport direction as compared with the periphery of an opening of the first blowing port at the downstream side of the transport direction.

According to the above configuration, the first blowing port and the second blowing port, which have blowing directions different from each other, are installed, and blowing from the first blowing port and the second blowing port are properly stopped, so that the speed of the wind blowing toward the target is increased in a simple manner and thus the liquid can be dried at a higher speed while the flatness of the target is maintained.

According to the drying apparatus of the invention, the drying unit includes a first blowing section provided with the first blowing port, and a second blowing section provided with the second blowing port, the first blowing section and the second blowing section being arranged in parallel to each other such that portions of the first and second blowing sections along the transport direction are adjacent to each other in a width direction of the target, which is perpendicular to the transport direction.

According to the above configuration, the blowing sections with the same standard, which have the blowing direction along the transport direction, are arranged in parallel to each other such that the blowing direction indicates the first direction and the second direction opposite to the first direction, so that the manufacturing cost can be reduced through the standardization of the blowing sections.

According to the drying apparatus of the invention, the first blowing section has a trapezoidal shape in which a width of an upstream end thereof is smaller than a width of a downstream end thereof in the width direction when viewed in a plan view, and the second blowing section has a trapezoidal shape in which a width of an upstream end thereof is larger than a width of a downstream end thereof in the width direction when viewed in a plan view.

According to the above configuration, the portions of the first blowing section and the second blowing section, which have a trapezoidal shape, are adjacent to each other in the width direction, so that the positions of the target corresponding to the boundary lines between the first blowing section and the second blowing section vary depending on the transportation of the target. Thus, it is possible to make uneven drying unnoticed which is caused by the difference between the drying states in the boundary lines between the first blowing section and the second blowing section.

A recording apparatus of the invention includes a recording unit that attaches liquid to a target transported by a transport unit to perform a recording process on the target, and the drying apparatus having the above configuration.

According to the above configuration, the target with liquid attached thereto is subject to a drying process by the drying apparatus at a higher speed while the flatness of the target is maintained. Thus, distortion of an image caused by modification of the target, or contamination of the recording apparatus due to non-dried liquid attached to the target can be prevented, so that recording can be performed on the target.

According to a second aspect of the invention, there is provided a method for drying a target, which includes a first drying process of blowing wind toward an end portion of the target in a form of a cut sheet at a downstream side of a transport direction of the target at a first timing in a first direction from an upstream side to the downstream side of the transport direction of the target, the target being transported with liquid attached thereto to perform a drying operation, and a second drying process of blowing wind toward an end portion of the target at the upstream side of the transport direction of the target at a second timing delayed from the first timing in a second direction from the downstream side to the upstream side of the transport direction to perform a drying operation.

According to the above configuration, in the first drying process, if the target with the liquid attached thereto is transported, the end (that is, the front end in the transport direction) of the target at the downstream side of the transport direction is exposed to the wind at the first timing, which blows in the first direction from the upstream side to the downstream side of the transport direction. In the second drying process, the end (that is, the rear end in the transport direction) of the target at the upstream side of the transport direction is exposed to the wind at the second timing delayed from the first timing, which blows in the second direction from the downstream side to the upstream side of the transport direction. Thus, similarly to the drying apparatus having the above configuration, the speed of the wind blowing toward the target is increased, so that the liquid can be dried at a higher speed while the flatness of the target is maintained.

### BRIEF DESCRIPTION OF THE DRAWINGS

The invention will be described with reference to the accompanying drawings, wherein like numbers reference like elements.

FIG. 1 is a front view schematically showing a printer according to a first embodiment.

FIG. 2 is a plan view schematically showing a printer.

FIG. 3A is a view schematically showing a configuration of a first shape of a hot wind unit.

FIG. 3B is a view schematically showing a configuration of a second shape of a hot wind unit.

FIG. 3C is a view schematically showing a configuration of a third shape of a hot wind unit.

FIG. 4 is a sectional view schematically showing a hot wind unit according to a second embodiment.

FIG. 5 is a plan view schematically showing a hot wind unit according to a third embodiment.

### DESCRIPTION OF EXEMPLARY EMBODIMENTS

### First Embodiment

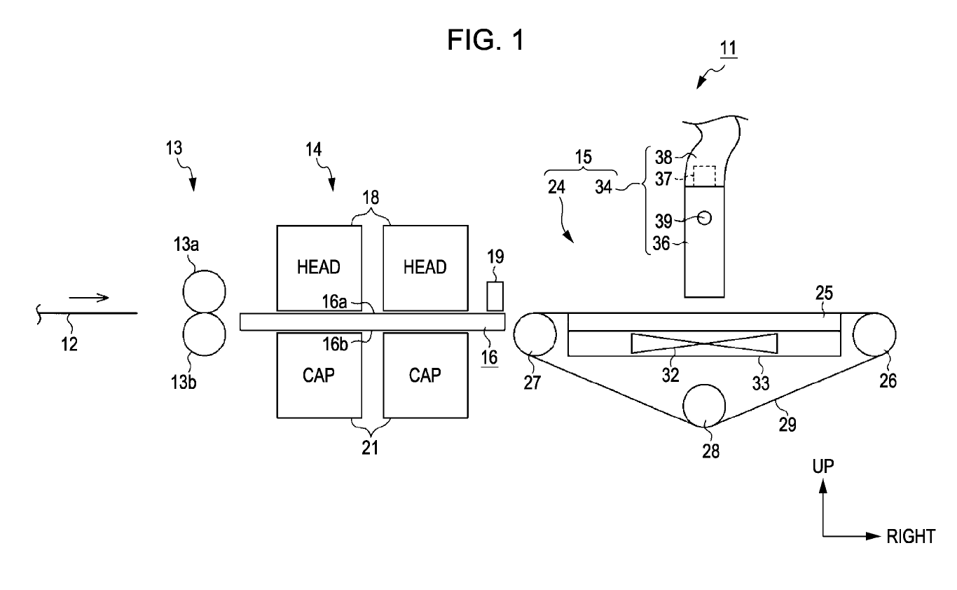

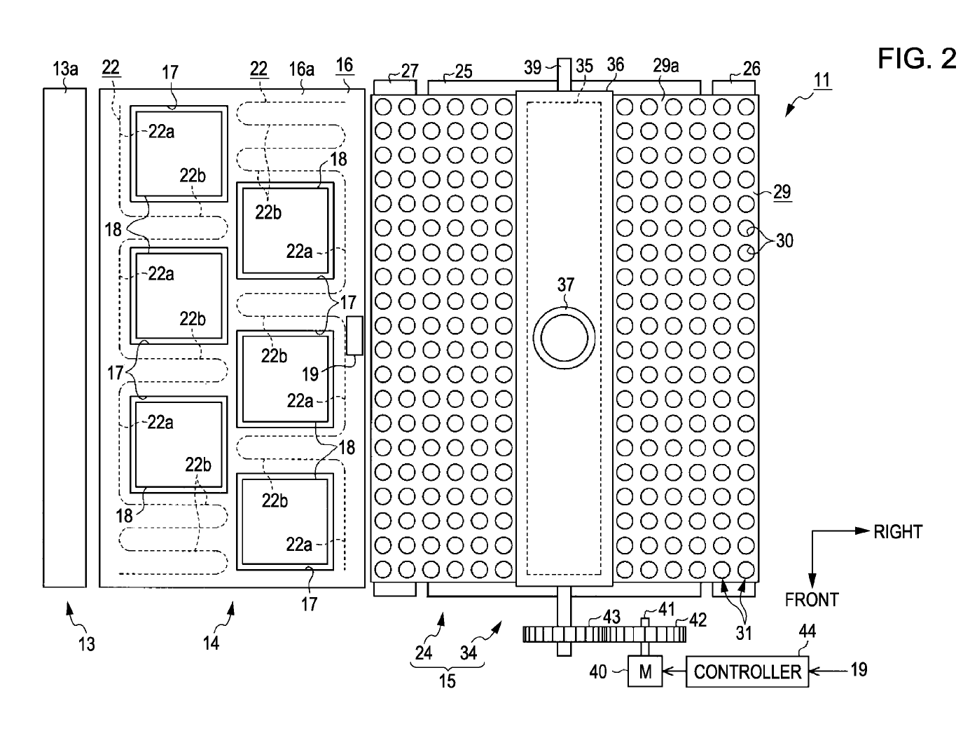

Hereinafter, a recording apparatus embodied as an ink jet printer (hereinafter, referred to as a printer) according to a first embodiment of the invention will be described with reference to FIGS. 1 to 3. In the following description, front and rear directions, right and left directions, and up and down directions refer to directions indicated by arrows shown in FIGS. 1 and 2.

As shown in FIGS. 1 and 2, the printer 11 serving as the recording apparatus includes a preheat device 13 that heats a sheet 12 which is supplied from a sheet feeding tray (not shown) as a target in the form of a cut sheet, a printing unit 14 that performs printing on the sheet 12 heated by the preheat device 13, and a drying device 15 that dries the sheet 12 so that printing is fixed. The sheet 12 dried by the drying device 15 is discharged to a sheet discharge tray (not shown).

The preheat device 13 includes a pair of upper and lower heat rollers 13a and 13b, which are arranged in both sides of the sheet 12 which is not printed, to nip the sheet 12 and send the sheet 12 to the printing unit 14 one by one. Further, the heat rollers 13a and 13b are heated by a heater (not shown). That is, the sheet 12 is heated by heat from the heat rollers 13a and 13b when the sheet 12 is nipped by the heat rollers 13a and 13b.

Next, the printing unit 14 will be described.

The printing unit 14 includes a platen 16 having a rectangular shape, and an upper surface 16a of the platen 16 serves as a transport path of the sheet 12. Further, the platen 16 is formed with a plurality of rectangular through holes 17 (six through holes in the embodiment) which are formed through the upper surface 16a and the lower surface 16b of the platen 16 in a zigzag manner in the width direction (front and rear directions) of the sheet 12, which are perpendicular to the transport direction (right and left directions) of the sheet 12.

Further, recording heads 18 in the same quantity as the number of the through holes 17 are arranged on the upper surface of the platen 16 in a zigzag manner such that no gap is formed in the front and rear directions. The recording heads 18 correspond to the through holes 17 in the up and down directions.

Further, a plurality of nozzles (not shown) are formed on nozzle installation surfaces serving as the lower surfaces of the recording heads 18 to eject ink (liquid) toward the sheet 12 transported along the upper surface 16a of the platen 16 while forming a plurality of nozzle arrays along the front and rear directions. Further, various types (colors) of inks are supplied to the nozzle arrays in the recording heads 18 from an ink cartridge (not shown), and then are ejected toward the sheet 12 from the nozzles of each nozzle array, so that printing is performed as a recording process.

Further, a sheet end detection sensor 19 is provided at a downstream side (right side) of the transport direction beyond the recording heads 18 above the platen 16 to detect right and left ends of the sheet 12 having passed the printing unit 14 after being carried from the preheat device 13.

Meanwhile, as shown in FIG. 1, caps 21 in the same quantity as the number of the through holes 17 are installed below the platen 16 in a zigzag manner in correspondence with the through holes 17 in the up and down directions. Each cap 21 is provided with a movable unit (not shown) that moves the cap 21 in the up and down directions. Thus, if the caps 21 move upward through the through holes 17 as the movable unit is driven, the caps 21 make contact with the nozzle arrays with respect to the nozzle installation surfaces of the recording heads 18, to which the through holes 17 correspond, while surrounding the nozzle arrays.

As shown in FIG. 2, a plurality of platen heaters 22 (two heaters in the embodiment) are installed in the platen 16. Each platen heater 22 generates heat by current applied from a heating unit (not shown) to heat the platen 16.

Further, the platen heaters 22 have the same shapes and are point symmetrically formed about the center of the platen 16. In detail, each platen heater 22 is formed with a meander shape with a point-symmetric arrangement by bending one member having a rectangular shape, which extends in the front and rear directions, many times such that the member is prevented from making contact with the through holes 17. Further, each platen heater 22 includes a plurality of first heating units 22a (three heating units in the embodiment), which are disposed between both ends of the platen 16 in the right and left directions and the through holes 17, and a plurality of second heating units 22b (four heating units in the embodiment), which are each formed by bending the first heating units 22a in the right and left directions and are disposed between the through holes 17 and between the through holes 17 and both ends of the platen 16 in the front and rear directions.

Then, the drying device 15 will be described.

As shown in FIGS. 1 and 2, the drying device 15 is provided with a transport unit 24 serving as a transport device to support and pull a front end of the sheet 12, which is carried from the preheat unit 13, in such a manner that the sheet 12 slidably moves along the upper surface 16a of the platen 16 in the printing unit 14.

The transport unit 24 includes a rectangular support plate 25 having a width wider than that of the sheet 12. A driving roller 26 extending in the front and rear directions is provided at a right side of the support plate 25 and is rotated by a driving motor (not shown). Further, a driven roller 27 extending in the front and rear directions is provided at a left side of the support plate 25 and is rotated together with the driving roller 26. Further, a tension roller 28 extending in the front and rear directions is provided below the support plate 25 and is rotated together with the driving roller 26 and the driven roller 27.

One endless belt 29 serving as a support member is wound around the driving roller 26, the driven roller 27 and the tension roller 28 to surround the support plate 25. When the belt 29 slidably moves on the support plate 25, a support surface 29a of the belt 29 coincides with the upper surface 16a of the platen 16. Further, the tension roller 28 is urged downward by a spring member (not shown) so that tension is applied to the belt 29, thereby preventing the belt 29 from being loosened.

Further, the driving roller 26 is rotated clockwise by a driving motor (not shown) when viewed in a front view, so that the belt 29 is rotated (driven) clockwise along an outer side of the driving roller 26, the tension roller 28 and the driven roller 27 when viewed in a front view. In such a case, an inner surface of the belt 29 slidably moves along an upper surface of the support plate 25 from the left side to the right side, so that the sheet 12 on the belt 29 is supported by the support surface 29a and is transported from the left side (upstream side) to the right side (downstream side).

The belt 29 is formed with a plurality of air holes 30 which extend through the support surface 29a, which supports the sheet 12, and a rear surface that makes sliding-contact with the support plate 25. Further, the air holes 30 are regularly arranged such that a plurality of air hole arrays 31 disposed in the front and rear directions are spaced apart from each other in the right and left direction at predetermined intervals.

Further, the support plate 25 is formed with a plurality of absorption holes (not shown) which vertically extend through the support plate 25, that is, which are formed in the thickness direction of the support plate 25. An absorption unit 33 having a casing shape and a fan 32 therein is installed below the support plate 25 to cover openings of the absorption holes formed through a lower surface of the support plate 25. Further, as the fan 32 is driven, the absorption holes are in a negative pressure state, so that absorption force is applied downward to the sheet 12 loaded on the belt 29 through the air holes 30 which communicate with the absorption holes.

Further, a hot wind unit 34 serving as a drying unit is installed above the transport unit 24 to promote drying of the sheet 12 transported to the transport unit 24 after being printed by the printing unit 14.

As shown in FIG. 2, the hot wind unit 34 is formed at a lower surface thereof in opposition to the sheet 12 with a blowing port 35, and includes a blowing unit 36 which is provided over the width direction of the sheet 12 and has a rectangular shape when viewed in a plan view. Further, a connection pipe 37 communicating with the blowing port 35 protrudes upward from the center portion of the blowing unit 36 in the front and rear directions. Further, as shown in FIG. 1, the connection pipe 37 is connected to a front end of a flexible duct 38 which is provided at a base part thereof with a blowing fan (not shown) and a heater (not shown). That is, the hot wind unit 34 blows the hot wind, which is supplied from the duct 38, toward the surface of the sheet 12 with the ink attached thereto through the blowing port 35, thereby drying the ink so that printed content can be fixed on the sheet 12.

Further, the blowing unit 36 is supported by a bracket (not shown) through a shaft 39 extending through the blowing unit 36 in the front and rear directions, and is rotated together with the shaft 39. In detail, the shaft 39 is provided at a front end thereof with a driven geared wheel 43 which is engaged with a driving geared wheel 42 installed at a driving shaft 41 of a rotary actuator motor 40.

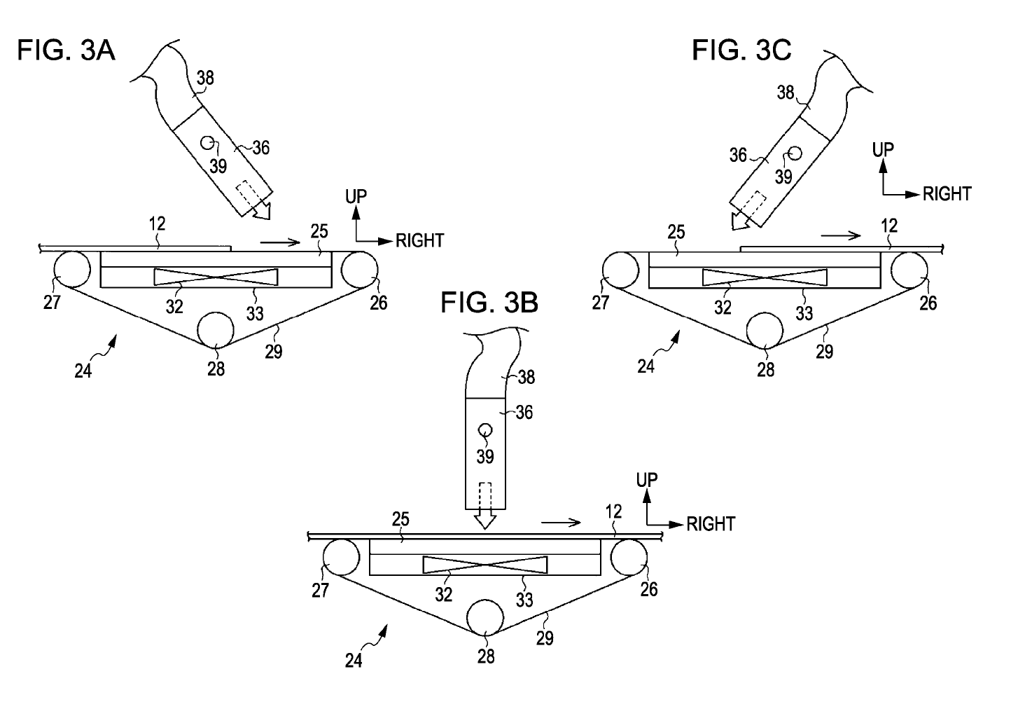

According to the above configuration, if a controller 44 controls the rotary actuator motor 40 to rotate in the forward direction according to a detection result of the sheet end detection sensor 19, the blowing unit 36 is rotated counterclockwise when viewed in a front view, so that the blowing port 35 is directed rightward as shown in FIG. 3A. That is, the blowing unit 36 is in a first state in which the blowing unit 36 blows wind in a right direction (first direction) from the upstream side (left side) to the downstream side (right side) of the transport direction of the sheet 12 as indicated by a white arrow.

Meanwhile, if the controller 44 controls the rotary actuator motor 40 to rotate in the reverse direction, the blowing unit 36 is rotated clockwise, the blowing unit 36 is in a second state in which the blowing unit 36 blows wind toward an ink attachment surface of the sheet 12 in the down direction (vertical direction) as shown in FIG. 3B.

Further, if the rotary actuator motor 40 is rotated in the reverse direction, the blowing port 35 is directed leftward as shown in FIG. 3C. In detail, the blowing unit 36 is in a third state in which the blowing unit 36 blows wind in a left direction (second direction) from the downstream side (right side) to the upstream side (left side) of the transport direction of the sheet 12.

Further, if the rotary actuator motor 40 is rotated in the forward direction in the third state, the blowing unit 36 is switched from the second state to the first state. That is, according to the embodiment, the shaft 39, the rotary actuator motor 40, the driving shaft 41, the driving geared wheel 42, the driven geared wheel 43 and the controller 44 serve as a wind direction change section to change the angle of the blowing port 35 with respect to the sheet 12. Further, the controller 44 controls the rotary actuator motor 40 to be shaken within a shaking angle at which the blowing unit 36 is switched from the first state to the third state via the second state.

Hereinafter, the operation of the printer 11 having the configuration as described above will be described while focusing on the drying operation of the drying device 15, which is performed on the sheet 12 after the printing has been completed.

When the printing is performed, the heater that heats the heat rollers 13a and 13b, the platen heater 22 and a heater that heats air in the duct 38 are heated through current applied thereto such that they reach the temperature suitable for the printing. At this time, the heat rollers 13a and 13b are rotated and simultaneously the driving roller 26 is rotated, so that the belt 29 is rotated.

If the sheet 12 is supplied from a sheet feeding tray (not shown), the sheet 12 is nipped by the heat rollers 13a and 13b being rotated and is sent to the printing unit 14. At this time, the sheet 12 is preheated (preliminary heating) by heat from the heat rollers 13a and 13b.

Further, the printing unit 14 performs the printing process by ejecting ink toward the sheet 12 slidably moving on the platen 16 after being carried from the preheat device 13, and the sheet end detection sensor 19 detects the front end of the sheet 12. Then, the controller 44 controls the rotary actuator motor 40 to rotate in the forward direction, so that the blowing unit 36 is shaken and comes into the first state. Further, the transport unit 24 absorbs the sheet 12 carried from the preheat device 13, loads the sheet 12 on the belt 29, and transports the sheet 12 rightward.

Thus, as shown in FIG. 3a, the front end of the sheet 12 in the transport direction, which is transported after being loaded on the belt 29, that is, the end of the sheet 12 at the downstream side (right side) of the transport direction, is exposed to hot wind at a first timing, which blows in the right direction. That is, the sheet 12 is exposed to the hot wind blowing in the direction opposite to the direction in which the sheet 12 is rolled up, so that the sheet 12 is pressed to the support surface 29a of the belt 29 and is transported (first drying process).

Further, the controller 44 calculates a timing, at which the front end of the sheet 12 is carried from the transport unit 24, based on the rotation speed of the belt 29 (rotation speed of the driving roller 26) to control the rotary actuator motor 40 to rotate in the reverse direction. Thus, the blowing unit 36 is in the second state as shown in FIG. 3B.

Further, if the sheet 12 is transported and the sheet end detection sensor 19 detects the end of the sheet 12 at the upstream side (left side) of the transport direction, that is, the rear end (the rear end of the sheet 12 in the transport direction), the controller 44 controls the rotary actuator motor 40 to rotate in the reverse direction at the second timing, so that the blowing unit 36 comes into the third state as shown in FIG. 3C. Thus, the rear end of the sheet 12 is exposed to hot wind, which blows in the left direction, at the second timing delayed from the first timing (second drying process). That is, the sheet 12 is exposed to the hot wind blowing in the direction opposite to the direction in which the sheet 12 is rolled up, so that the sheet 12 is pressed to the support surface 29a of the belt 29 and is discharged to a sheet discharge tray (not shown).

According to the first embodiment, the following effects can be obtained.

(1) if the sheet 12, on which printing has been performed through attachment of ink, is transported by the transport unit 24, the front end of the sheet 12 is exposed to wind blowing in the right direction. In detail, when the sheet 12 being transported approaches the hot wind unit 34, the front end of the sheet 12 is exposed to wind blowing in the direction opposite to the direction in which the front end of the sheet 12 is rolled up, so that the sheet 12 is pressed to the belt 29. Then, when the sheet 12 is transported rightward beyond the hot wind unit 34, the rear end of the sheet 12 is exposed to wind blowing in the direction opposite to the direction in which the end of the sheet 12 is rolled up, that is, in the left direction, so that the sheet 12 is pressed to the belt 29. That is, the hot wind unit 34 can perform the drying process by blowing the wind such that the front and rear ends of the sheet 12 are pressed to the belt 29. Thus, the ink can be dried at a higher speed by increasing the speed of the wind blowing toward the sheet 12 while the flatness of the sheet 12 is maintained.

(2) in relation to the hot wind unit 34, the controller 44 controls the rotary actuator motor 40 to rotate in the forward direction and the reverse direction to change the angle of the blowing port 35 with respect to the sheet 12, so that the direction of the wind blowing toward the sheet 12 can be changed. That is, when the front end of the sheet 12 being transported approaches a position corresponding to the blowing port 35 of the hot wind unit 34, the rotary actuator motor 40 is rotated in the forward direction, so the blowing port 35 is directed rightward, so that the sheet 12 can be exposed to the wind blowing in the first direction. Then, when the sheet 12 is transported and the rear end of the sheet 12 passes through the position corresponding to the blowing port 35 of the hot wind unit 34, the blowing port 35 is directed leftward, so that the sheet 12 can be exposed to the wind blowing in the second direction. Thus, the front and rear ends of the sheet 12 can be prevented from being rolled up through this simple configuration, so that the drying process can be performed.

(3) the sheet 12 with the ink attached thereto is promptly subject to the drying process by the drying device 15 in a state in which the flatness of the sheet 12 is maintained. Thus, distortion of an image due to modification of the sheet 12 or contamination of the printer 11 due to non-dried ink attached to the sheet 12 can be prevented, so that recording can be performed on the sheet 12.

### Second Embodiment

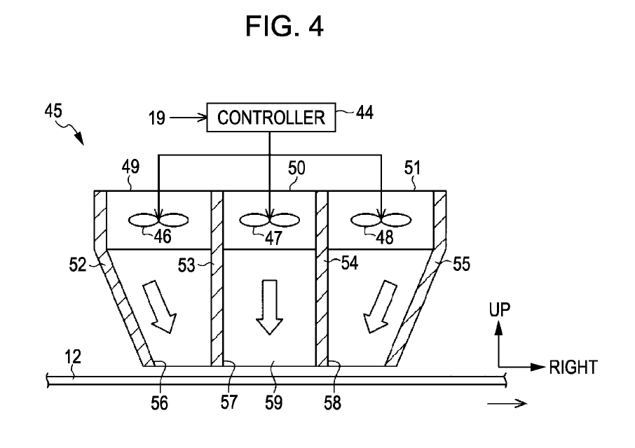

Hereinafter, the second embodiment of the invention will be described with reference to FIG. 4. Since the second embodiment is identical to the first embodiment except that the hot wind unit is changed, the same reference numerals are used to designate the same elements and detailed description thereof will be omitted.

The hot wind unit 45 includes three blowing fans 46, 47 and 48 and three heaters (not shown), which are provided in partitioned blowing units 49, 50 and 51, respectively. Right and left sidewalls of the blowing unit 49 include guide plates 52 and 53 which are installed in a width direction (front and rear directions) of the sheet 12 while extending toward the sheet 12 transported by a transport unit (not shown). Right and left sidewalls of the blowing unit 50 include guide plates 53 and 54 which are installed in the width direction (front and rear directions) of the sheet 12 while extending toward the sheet 12 transported by the transport unit (not shown). Right and left sidewalls of the blowing unit 51 include guide plates 54 and 55 which are installed in the width direction (front and rear directions) of the sheet 12 while extending toward the sheet 12 transported by the transport unit (not shown).

Further, front and rear sidewalls of each of the blowing units 49, 50 and 51 are vertically formed by a front plate (not shown) and a rear plate 59 which have a size identical to the size of each of the guide plates 52, 53, 54 and 55. That is, the first blowing unit 49 installed at the left side of the hot wind unit 45 blows wind toward the sheet 12 from a blowing port 56 (first blowing port) surrounded by the first guide plate 52, the second guide plate 53, and the front plate and the rear plate 59. Similarly to this, the second blowing unit 50 installed at the center portion of the hot wind unit 45 blows wind toward the sheet 12 from a blowing port 57 surrounded by the second guide plate 53, the third guide plate 54, and the front plate and the rear plate 59. Further, the third blowing unit 51 installed at the right side of the hot wind unit 45 blows wind toward the sheet 12 from a blowing port 58 (second blowing port) surrounded by the third guide plate 54, the fourth guide plate 55 and the front plate and the rear plate 59.

In addition, the guide plates 52, 53, 54 and 55 are installed in such a manner that the adjacent guide plates 52 and 53 face each other, the adjacent guide plates 53 and 54 face each other, and the adjacent guide plates 54 and 55 face each other in the right and left directions, so that the right and left ends of an opening of the blowing port 56 are located at the upstream side as compared with the right and left ends of an opening of the blowing port 58. Further, the first guide plate 52 installed at the leftmost side of the hot wind unit 45 is bent in such a manner that a lower portion of the first guide plate 52 is inclined rightward. Similarly to this, the fourth guide plate 55 installed at the rightmost side of the hot wind unit 45 is bent in such a manner that a lower portion of the fourth guide plate 55 is inclined leftward.

According to the above configuration, as the first blowing fan 46 is driven, the first blowing unit 49 blows wind from the blowing port 56 along the first guide plate 52 in the right direction (first direction) from the left side to the right side as indicated by a white arrow. Further, as the second blowing fan 47 is driven, the second blowing unit 50 blows wind toward the sheet 12 from the blowing port 57 along the second and third guide plates 53 and 54 in the down direction (vertical direction). Further, as the third blowing fan 48 is driven, the third blowing unit 51 blows wind from the blowing port 58 along the fourth guide plate 55 in the left direction (second direction) from the right side to the left side.

Hereinafter, the operation of the hot wind unit 45 having the configuration as described above will be described. First, the blowing fans 46, 47 and 48 are in an initial state and the operation thereof is stopped. If the sheet end detection sensor 19 detects the front end of the sheet 12 which is transported from the left side to the right side after printing has been completed, the controller 44 serving as a blowing stop section drives the first blowing fan 46. Thus, the sheet 12 transported by the transport unit 24 is exposed to wind at the first timing, which blows in the right direction opposite to the direction in which the front end of the sheet 12 is rolled up, so that the sheet 12 passes through the hot wind unit 45 while being pressed to a belt (not shown) (first drying process).

Further, the controller 44 drives the second blowing fan 47 and the third blowing fan 48 at a timing, at which the front end of the sheet 12 has passed through the hot wind unit 45, based on a transport speed at which the sheet 12 is transported. Thus, the sheet 12 is dried by the wind from the first to third blowing units 49 to 51 (see FIG. 4).

Then, if the sheet 12 is further transported and the sheet end detection sensor 19 detects the rear end of the sheet 12, the controller 44 stops driving the first blowing fan 46 and the second blowing fan 47. Thus, the rear end of the sheet 12 is exposed to wind blowing from the third blowing unit 51 at the second timing in the left direction opposite to the direction in which the rear end of the sheet 12 is rolled up, so that the sheet 12 is pressed to the belt (not shown) and is discharged to a sheet discharge tray (second drying process).

According to the second embodiment, the following effects can be further obtained in addition to the above effects (1) to (3) according to the first embodiment.

(4) the blowing port 56 and the blowing port 58, which have blowing directions different from each other, are installed, and the blowing from the blowing port 56 and the blowing port 58 is properly stopped, so that the speed of the wind blowing toward the sheet 12 is increased in a simple manner and thus the ink can be dried at a higher speed while the flatness of the sheet 12 is maintained.

### Third Embodiment

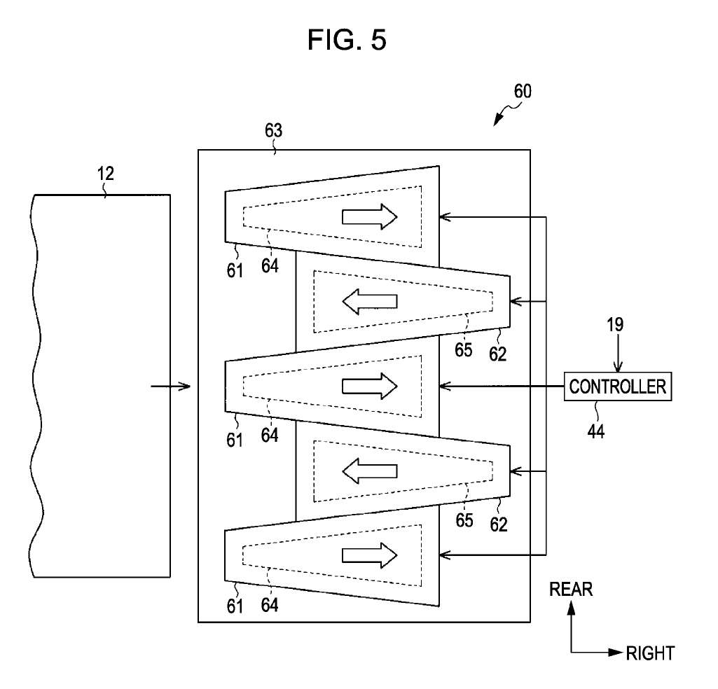

Hereinafter, the third embodiment of the invention will be described with reference to FIG. 5. Since the third embodiment is identical to the previous embodiments except that the hot wind unit is changed, the same reference numerals are used to designate the same elements and detailed description thereof will be omitted.

As shown in FIG. 5, the hot wind unit 60 includes a first drying unit 61 serving as a first blowing unit, a second drying unit 62 serving as a second blowing unit, and a plate 63 having a rectangular shape. The first and second drying units 61 and 62 have a trapezoidal shape when viewed in a plan view while being fixed to the plate 63, and are arranged in parallel to each other such that portions of the first and second drying units 61 and 62 along the right and left directions are adjacent to each other in the front and rear directions.

In detail, the hot wind unit 60 includes at least one first drying unit 61 (three drying units in the embodiment) installed in the front and rear directions, in which widths of right and left ends in the front and rear directions are different from each other (this represents a trapezoidal shape when viewed in a plan view). Further, at least one second drying unit 62 (two drying units in the embodiment) is installed between the first drying units 61 while being located rightward beyond the first drying units 61, so that the second drying units 62 are adjacent to the first drying units 61 which are adjacent to each other in the front and rear directions.

Further, blowing fans (not shown), which supply air to blowing passages installed in the first drying unit 61 and the second drying units 62 along the right and left directions, and heaters (not shown), which heat the air supplied through the blowing fans, are separately installed in the left end portion of the first drying unit 61 and the right end portion of the second drying units 62.

In addition, the first drying unit 61 is provided with a blowing port 64 (first blowing port) which has a trapezoidal shape to blow hot wind in the blowing passage toward the sheet 12 being transported. Further, the second drying unit 62 is provided with a blowing port 65 (second blowing port) which blows hot wind in the blowing passage toward the sheet 12 being transported.

According to the above configuration, as the blowing fan of the first drying unit 61 is driven, blowing is performed in the first drying unit 61 in the right direction (first direction) from the left side, at which the width of the first drying unit 61 is small, to the right side at which the width of the first drying unit 61 is large. Thus, the sheet 12 is exposed to the hot wind blowing from the blowing port 64 in the right direction.

Similarly to this, as the blowing fan of the second drying unit 62 is driven, blowing is performed in the second drying unit 62 in the left direction (second direction) from the right side, at which the width of the second drying unit 62 is small, to the left side at which the width of the second drying unit 62 is large. Thus, the sheet 12 is exposed to the hot wind blowing from the blowing port 65 in the left direction.

According to the hot wind unit 60 of the embodiment, the first drying unit 61 and the second drying unit 62, which have the same configuration, are installed such that the blowing directions of the first drying unit 61 and the second drying unit 62 are opposite to each other. Thus, the periphery of an opening of the blowing port 64 at the upstream side (left side) of the transport direction is located at the left side as compared with the periphery of a left opening of the blowing port 65. Further, the periphery of an opening of the blowing port 65 at the downstream side (right side) of the transport direction is located at the right side as compared with a the periphery of a right opening of the blowing port 64.

According to the above configuration, the controller 44 serving as a blowing stop section controls the blowing fans based on a detection result of the sheet end detection sensor 19 to control the blowing in the drying units 61 and 62, so that the hot wind can blow toward the sheet 12 from the blowing ports 64 and 65 or not.

Hereinafter, the operation of the hot wind unit 60 having the configuration as described above will be described.

First, if the sheet end detection sensor 19 detects the front end of the sheet 12 on which printing has been performed by the printing unit 14, the controller 44 starts blowing in the first drying unit 61 and the second drying unit 62. Thus, the sheet 12 transported by a transport unit (not shown) is exposed to the wind from the first drying unit 61 at the first timing in the right direction opposite to the direction in which the front end of the sheet 12 is rolled up (first drying process). Consequently, the sheet 12 is pressed to a belt (not shown) and is transported.

Then, if the front end of the sheet 12 is transported to a position corresponding to the second drying unit 62, the sheet 12 is exposed to wind in the left direction from the second drying unit 62 (blowing process). At this time, the sheet 12 is exposed to the wind blowing in the right direction from the first drying unit 61, so that the flatness of the sheet 12 is maintained.

The controller 44 calculates the timing, at which the front end of the sheet 12 is located at the right end of the first drying unit 61, based on the transport speed of the sheet 12 to stop the blowing in the second drying unit 62 (stop process at the downstream side). Thus, the front end of the sheet 12 is not subject to the wind blowing in the right direction opposite to the direction in which the front end of the sheet 12 is rolled up, and simultaneously the wind blowing in the left direction, in which the front end of the sheet 12 is rolled up, is stopped, so that the front end of the sheet 12 is loaded on the belt (not shown) and is transported. Then, the controller 44 starts the blowing in the second drying unit 62 at the timing at which the front end of the sheet 12 passes through the hot wind unit 60.

As the sheet 12 is further transported, if the rear end of the sheet 12 is detected by the sheet end detection sensor 19, the controller 44 stops the operation of the first drying unit 61 (stop process at the upstream side). When the rear end of the sheet 12 being transported passes through the first drying unit 61, the effect of the wind in the right direction, which denotes the roll up direction, is stopped.

Further, the controller 44 starts the blowing in the first drying unit 61 at the timing, at which the rear end of the sheet 12 is located at the left end of the second drying unit 62, based on the transport speed of the sheet 12. That is, since the rear end of the sheet 12 is exposed to the wind from the second drying unit 62 in the left direction opposite to the roll up direction, although the rear end of the sheet 12 is exposed to the wind from the first drying unit 61 in the right direction serving as the roll up direction, the sheet 12 is transported while the flatness of the sheet 12 is maintained.

Then, although the rear end of the sheet 12 passes through the first drying unit 61 and is not subject to the hot wind in the right direction (second timing), the wind in the left direction from the second drying unit 62 continuously blows, so that the sheet 12 is pressed to the belt (not shown) and is discharged to a sheet discharge tray (not shown) (second drying process).

According to the third embodiment, the following effects can be further obtained in addition to the above effects (1) to (4) according to the previous embodiments.

(5) the drying units 61 and 62 with the same standard, which have the blowing direction along the transport direction, are arranged in parallel to each other such that the blowing direction indicates the left direction and the right direction opposite to the left direction, so that the manufacturing cost can be reduced through the standardization of the drying units 61 and 62.

(6) the portions of the first drying units 61 and the second drying units 62, which have a trapezoidal shape, are adjacent to each other in the front and rear directions, so that the positions of the sheet 12 corresponding to the boundary lines between the first drying units 61 and the second drying units 62 vary depending on the transportation of the sheet 12. Thus, it is possible to make uneven drying unnoticed which is caused by the difference between the drying states in the boundary lines between the first drying units 61 and the second drying units 62.

Further, the previous embodiments can be modified as follows.

Differently from the third embodiment, in relation to the blowing passage of the first drying unit 61, the sectional area of the blowing passage at the upstream side (left side) of the transport direction of the sheet 12 may be smaller than the sectional area of the blowing passage at the downstream side (right side) of the transport direction. Further, in relation to the blowing passage of the second drying unit 62, the sectional area thereof at the left side of the transport direction may be larger than the sectional area thereof at the right side of the transport direction.

Further, the force, by which the sheet 12 is pressed to the belt, is increased proportionally to the speed of wind blowing toward the sheet 12. Further, the speed of the wind blowing from the blowing ports 64 and 65 after passing through the blowing passage is increased as the sectional area of the blowing passage is reduced. Thus, the sectional area of the blowing passage of the first drying unit 61 is small at the left side and is large at the right side, so that the speed of the wind passing through the blowing passage becomes faster at the left side and becomes slower at the right side. Meanwhile, the sectional area of the blowing passage of the second drying unit 62 is large at the left side and is small at the right side, so that the speed of the wind passing through the blowing passage becomes slower at the left side and becomes faster at the right side. Consequently, the front end of the sheet 12 transported to the hot wind unit 60 is pressed to the belt by the wind with a high speed in the right direction from the first drying unit 61 and is exposed to the wind with a low speed in the left direction from the second drying unit 62, so that the front end of the sheet 12 can be effectively prevented from becoming rolled up. Similarly to this, although the rear end of the sheet 12 is exposed to the wind blowing from the first drying unit 61 in the right direction in which the rear end thereof is easily rolled up, the rear end of the sheet 12 is exposed to the wind with a high speed blowing from the second drying unit 62 in the left direction in which the rear end thereof is pressed to the belt, so that the rear end of the sheet 12 can be effectively prevented from becoming rolled up.

Differently from the third embodiment, the first drying unit 61 and the second drying unit 62 may have various shapes. For example, the first drying unit 61 and the second drying unit 62 may have a rectangular shape or a triangular shape when viewed in a plan view. In the second and third embodiments, shutters serving as blowing stop sections may be installed to close the blowing ports 56, 57, 58, 64 and 65. Further, the controller 44 may open the shutters, which correspond to the blowing ports 56, 57, 58, 64 and 65, at the driving timing of the blowing fan.

Differently from the second embodiment, an arrangement sequence of the first to third blowing units 49, 50 and 51 may be arbitrarily changed. Further, the second blowing unit 50 may be omitted. For example, the third blowing unit 51 may be installed at the upstream side (left side) of the transport direction and the first blowing unit 49 may be installed such that the first blowing unit 49 is adjacent to the third blowing unit 51 at the right side. Further, wind may blow from the blowing units 49 and 51 when the front end of the sheet 12 has passed through the blowing port 58 of the third blowing unit 51, and the blowing of the first blowing units 49 may be stopped at the time point at which the rear end of the sheet 12 has passed through the third blowing unit 51, so that the sheet 12 can be transported while being pressed to the belt.

Differently from the first embodiment, a blowing unit fixedly arranged with respect to the sheet 12 being transported may be employed as a wind direction change section, a base member may be installed at a blowing port of the blowing unit, and at least two wings may be installed in the front and rear directions to change the wind direction through sliding movement of the front ends of the wings.

Differently from the previous embodiments, a continuous forms paper having a surface, to which ink is attached through other printing schemes such as screen printings without using ink ejection through the recording head 18, may be transported on the transport unit 24 and may be dried.

According to the previous embodiments, the liquid ejecting apparatus is embodied as the ink jet printer 11. However, a liquid ejection apparatus for ejecting or exhausting liquid other than ink may be employed. The liquid ejecting apparatus is available for various liquid ejection apparatuses provided with a liquid ejection head that exhausts a small amount of liquid droplets. For example, the liquid droplets are in a liquid state, which are exhausted from the liquid ejection apparatus, and may include a grain shape with a long tail, teardrops with a long tail, and a thread shape with a long tail. Further, the liquid may include various materials which can be ejected from the liquid ejection apparatus. For example, the liquid may denote materials in a liquid phase, and may include liquid-phase materials having high or low viscosity, sol, gel water, and materials in a flowing state such as inorganic solvents, organic solvents, solutions, liquid phase resin and liquid phase materials (metal melt). Further, the liquid may include materials, which are obtained through dissolution, dispersion or mixing between particles of functional materials including solid materials (e.g., pigments or metal particles) and solvent, as well as liquid as one state of material. Further, the ink as described in the previous embodiments, liquid crystal or the like is a representative example of the liquid. The ink may include various liquid compositions such as normal water-based ink, solvent-based ink, gel ink and hot melt ink. For example, the liquid ejection apparatus may include a liquid ejection apparatus that ejects liquid including dispersed or dissolved electrode materials or color materials, which are used for manufacturing a liquid crystal display, an electroluminescence display, a surface emitting display, a color filter and the like, a liquid ejection apparatus that ejects bio-organic materials used for manufacturing a bio chip, a liquid ejection apparatus used as a precise pipette to eject liquid, a dyeing apparatus, a micro-dispenser and the like. In addition, it is possible to employ a liquid ejection apparatus that ejects lubricating oil to a precision apparatus such as a watch or a camera through a pin point, a liquid ejection apparatus that ejects transparent resin solution, such as UV curing resin, onto a substrate to form a micro hemispheric lens (optical lens) used for a light communication device and the like, and a liquid ejection apparatus that ejects etchant such as acid or alkali to etch a substrate. Further, the invention can be applied to at least one of the liquid ejection apparatuses.

The technical scope derived from the previous embodiments and the modifications is as follows.

According to the technical scope, there is provided a method for drying a target, the method including a process of blowing wind toward the transported target in the form of a cut sheet, on which a recording process has been performed, in the first direction from the upstream side to the downstream side of the transport direction of the target, and the second direction from the downstream side to the upstream side of the transport direction, the stop process at the upstream side of stopping the wind blowing in the first direction toward the end of the target at the upstream side of the transport direction, and the stop process at the downstream side of stopping the wind blowing in the second direction toward the end of the target at the downstream side of the transport direction.

According to the above configuration, in the stop process at the upstream side, if the target, on which the recording process has been performed, is transported, in relation to the drying process for the rear end of the target in the transport direction, the effect of the wind blowing in the first direction from the upstream side to the downstream side is stopped. Further, in the stop process at the downstream side, if the target, on which the drying process has been performed, is transported, in relation to the drying process for the front end of the target in the transport direction, the effect of the wind blowing in the second direction from the downstream side to the upstream side is stopped. That is, the wind in the direction (second direction), which is opposite to the roll up direction, remains in the rear end of the target in the transport direction, on which the recording process has been performed. Further, the wind in the direction (first direction), which is opposite to the roll up direction, remains in the front end of the target in the transport direction, on which the drying process has been performed. Thus, liquid attached to the target can be dried at a higher speed by increasing the speed of the wind blowing in the first direction and the second direction in a state in which the flatness of the target is maintained.

What is claimed is:

1. A drying apparatus comprising:
a transport unit that transports a target in a form of a cut sheet, on which a recording process has been performed through attachment of liquid, from an upstream side to a downstream side of a transport direction; and
a drying unit that performs a drying process on the target transported by the transport unit by blowing wind toward a liquid attachment surface of the target, a rear surface of the target being supported by a support surface of a support member,
wherein the drying unit is provided with a blowing port which allows wind to blow toward an end portion of the target at the downstream side of the transport direction in a first direction from the upstream side to the downstream side of the transport direction, and allows wind to blow toward an end portion of the target at the upstream side of the transport direction in a second direction from the downstream side to the upstream side of the transport direction.

2. The drying apparatus according to claim 1, wherein the drying unit includes a wind direction change section that changes a direction of wind, which blows from the blowing port to the target, by changing an angle of the blowing port with respect to the target.

3. The drying apparatus according to claim 1, wherein the drying unit includes:
a first blowing port through which wind blows in the first direction;
a second blowing port through which wind blows in the second direction; and
a blowing stop section that stops blowing from the first blowing port when the end portion of the target at the upstream side of the transport direction passes through a position corresponding to the first blowing port, and stops blowing from the second blowing port when the end portion of the target at the downstream side of the transport direction passes through a position corresponding to the second blowing port,
wherein a periphery of an opening of the first blowing port at the upstream side of the transport direction is located at the upstream side of the transport direction as compared with a periphery of an opening of the second blowing port at the upstream side of the transport direction, and
a periphery of an opening of the second blowing port at the downstream side of the transport direction is located at the downstream side of the transport direction as compared with a periphery of an opening of the first blowing port at the downstream side of the transport direction.

4. The drying apparatus according to claim 3, wherein the drying unit includes:
a first blowing section provided with the first blowing port; and
a second blowing section provided with the second blowing port,
wherein the first blowing section and the second blowing section are arranged in parallel to each other such that portions of the first and second blowing sections along the transport direction are adjacent to each other in a width direction of the target, which is perpendicular to the transport direction.

5. The drying apparatus according to claim 4, wherein the first blowing section has a trapezoidal shape in which a width of an upstream end thereof is smaller than a width of a downstream end thereof in the width direction when viewed in a plan view, and
the second blowing section has a trapezoidal shape in which a width of an upstream end thereof is larger than a width of a downstream end thereof in the width direction when viewed in a plan view.

6. A recording apparatus comprising:
a recording unit that attaches liquid to a target transported by a transport unit to perform a recording process on the target; and
the drying apparatus according to claim 1.

7. A method for drying a target, the method comprising:
a first drying process of blowing wind toward an end portion of the target in a form of a cut sheet at a downstream side of a transport direction of the target at a first timing in a first direction from an upstream side to the downstream side of the transport direction of the target, the target being transported with liquid attached thereto to perform a drying operation; and
a second drying process of blowing wind toward an end portion of the target at the upstream side of the transport direction of the target at a second timing delayed from the first timing in a second direction from the downstream side to the upstream side of the transport direction to perform a drying operation.
